(19) United States
(12) Patent Application Publication
(10) Pub. No.: US 2015/0175292 A1
(43) Pub. Date: Jun. 25, 2015

(54) CUPCAKE OR MUFFIN BOX

(71) Applicant: Jeffrey F. Craft, Calabasas, CA (US)

(72) Inventors: James McCullough, Riverside, CA (US); Jeffrey F. Craft, Calabasas, CA (US)

(73) Assignee: Casey's Cupcakes Holdings, LLC, Riverside, CA (US)

(21) Appl. No.: 14/119,838

(22) PCT Filed: May 23, 2012
(86) PCT No.: PCT/US12/39114

§ 371 Date: Oct. 9, 2014

Related U.S. Application Data
(60) Provisional application No. 61/489,623, filed on May 24, 2011.

(51) Int. Cl. B65D 5/24; A21D 13/08

(52) U.S. Cl. CPC B65D 5/243; A21D 13/08

(57) ABSTRACT

Disclosed is a container having a polygonal base having n sides, where n is an integer between 4 and 8, inclusive; n adjacent sidewalls, each sidewall having a top, a bottom, and first and opposing sides, the bottom of each sidewall attached to one of the sides of the polygonal base and the first side of each sidewall forming a corner with the second side of the adjacent sidewall; and at least one protrusion, each protrusion having a top protrusion edge extending inwardly from one of the sidewall corners.

### CROSS REFERENCE TO RELATED APPLICATION

This application claims the priority benefit of U.S. Provisional Patent Application Ser. No. 61/489,623, entitled “CUPCAKE OR MUFFIN BOX”, filed May 24, 2011, which application is hereby incorporated by reference in its entirety.

### BACKGROUND

1. Field of the Invention

The present invention relates to containers for storing and transporting food articles and, in particular, concerns a box for cupcakes, muffins and the like.

2. Description of the Related Art

Cupcakes and muffins are popular food items. Increasingly, these items are being sold in higher end coffee shops, food stores and dedicated bakeries. One example of such a dedicated bakery is Casey's Cupcakes in Riverside, Calif. Purchasers of high end muffins and cupcakes often purchase a single serving and will often want to take the product with them to eat at a later time, to share with others or to provide the cupcake or muffin to another person as a gift.

However, transportation of cupcakes or muffins can be complicated. This is particularly true when the cupcake or muffin has a topping such as icing and the like. If the container is larger than the cupcake or muffin, the cupcake or muffin may slide around in the container and portions of the cupcake or muffin may then be damaged as a result of contact with the inner sides of the container. However, making the container smaller may result in contact between the inner walls of the container and the outer edges of the cupcake or muffin which can also damage the appearance of the cupcake or muffin, particularly one that has intricate icing designs. Some designs of containers have been made where the cupcake or muffin are secured, but these designs often result in the portions of the container that contact the container digging into the base of the cupcake or muffin and further damaging it's aesthetic appearance.

Hence, there is a need for a cupcake or muffin container that inhibits the cupcake or muffin from moving inside the container but also does not result in contact between the cupcake or muffin and the interior walls of the container.

### SUMMARY OF THE INVENTION

The aforementioned needs are satisfied by the present invention. In one aspect, a container blank has a polygonal base section with n sides, where n is an integer between 4 and 8, inclusive; n sidewall sections, each sidewall section having a top, a bottom, and first and opposing sides, the bottom of each sidewall section attached to one of the opposing side of the polygonal base section; and at least one protrusion section, each protrusion section having first and second adjoining sides, the adjoining sides attached to adjacent sides of adjacent sidewall sections, and a top protrusion edge. Together they form an essentially flat container blank.

In some embodiments, each of the sidewall sections is attached to one of the sides of the polygonal base section by a base section fold line and each of the adjoining sides is attached to one of the adjacent sides of one of the adjacent sidewall sections by a side section fold line. And in some embodiments, each of the protrusion sections includes a foldable seam extending from the intersection of the adjacent sides the length of the protrusion section and the adjoining sides of the at least one protrusion section are attached to adjacent opposing sides of adjacent sidewall sections from the bottom of the sidewall section along at least a portion of the sidewall section side. In some embodiments, the top protrusion edge is straight, is convex or is concave.

In another aspect, a container includes a polygonal base having n sides, where n is an integer between 4 and 8, inclusive; n adjacent sidewalls, each sidewall having a top, a bottom, and first and opposing sides, the bottom of each sidewall attached to one of the sides of the polygonal base and the first side of each sidewall forming a corner with the second side of the adjacent sidewall; and at least one protrusion, each protrusion having a top protrusion edge extending inwardly from one of the sidewall corners. In some embodiments, the at least one top protrusion edge is disposed between the top and the bottom of the sidewall corner. And in some embodiments, the top protrusion edge is straight, is convex or is concave. Some embodiments additionally include a means, such as a lid, for securing the sidewalls in an upright position.

In still other aspects, a packaged article includes an article disposed in a container, where the container includes a polygonal base having n sides, where n is an integer between 4 and 8, inclusive; n adjacent sidewalls, each sidewall having a top, a bottom, and first and opposing sides, the bottom of each sidewall attached to a side of the polygonal base and the first side of each sidewall forming a corner with the second side of the adjacent sidewall; and at least one protrusion, each protrusion having a top protrusion edge extending inwardly from one of the sidewall corners, and each protrusion engaging the item and, in some embodiments each protrusion extending into the article. In some embodiments, the packaged article is a cupcake or a muffin, such as is a cupcake having a circular base and a frosting topping, the base diameter of the cupcake or muffin being from about 1½ inch to about 2½ inch and the height of the base of the cupcake or muffin being in some embodiments about 2 inches and a base from about ½ inch to about 1½. In such embodiments, the container may have a height of from about 1½ inches to about 2½ inches, a base with four sides of equal length, the length of each of the sides being from about 3 inches to about 4 inches, and each protrusions extending from the sidewall corner of adjacent sidewalls at a height of from about 1 inch to about 2 and extending inwardly from the sidewall corners at a distance of from ½ to about 1¼ inch. These and other objects and advantages will become more apparent from the following description taken in conjunction with the accompanying drawings.

### BRIEF DESCRIPTION OF THE DRAWINGS

FIG. 1 is a perspective view of an assembled embodiment of a container and associated lid;

FIG. 2 is a plan view of a container blank shown in FIG. 1;

FIG. 3 is a perspective view of a partially assembled container shown in FIG. 1; and

FIGS. 4A and B are perspective views of a partially assembled and an assembled container of FIG. 1 containing a cupcake; and

FIG. 5 is a plan view of a lid blank for the container of FIG. 1.

### DETAILED DESCRIPTION OF THE PREFERRED EMBODIMENTS

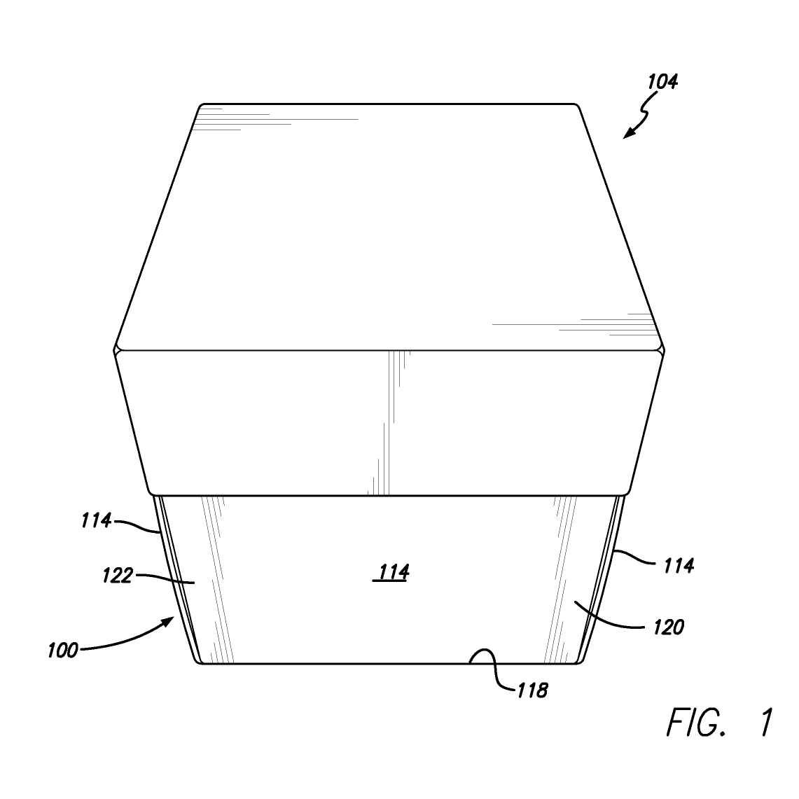

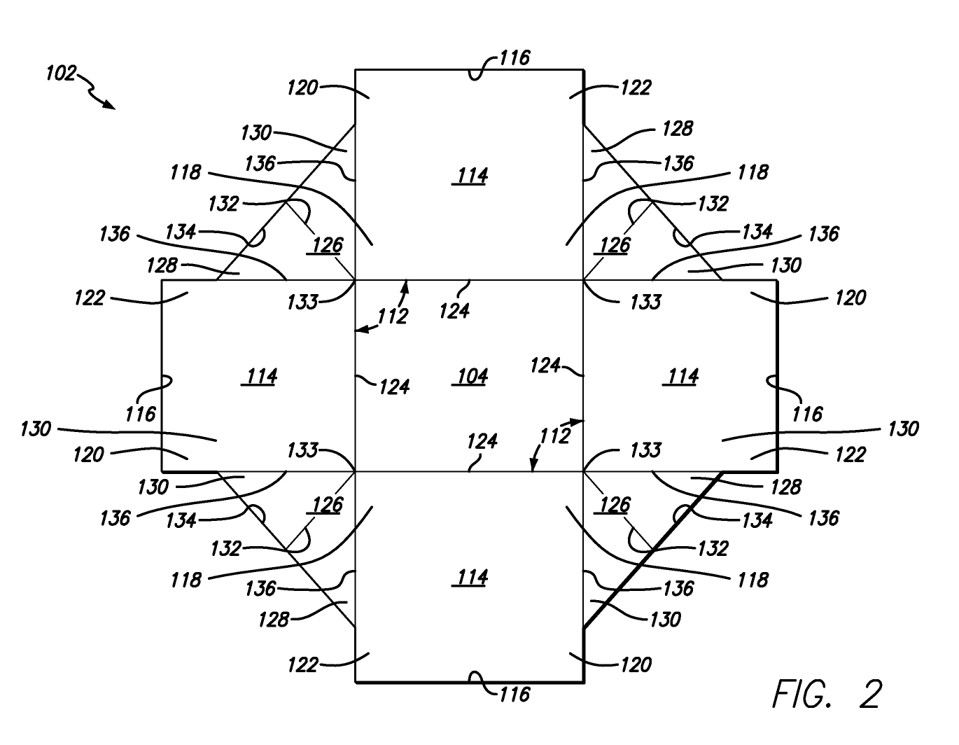

Reference will now be made to the drawings wherein like numerals refer to like parts throughout. Referring to FIG. 1, there is shown an assembled container 100, along with a lid or cover 104 for the container. As shown in FIG. 2, the container 100 is formed by folding a container blank 102 into the assembled shape shown in FIG. 1. The container blank 102 may be formed partially or completely out of a sheet of thin, foldable material, such as cardboard, paperboard, paper stock, corrugated, plastic, synthetic material, or combinations thereof.

The container blank 102 includes a polygonal base section 104 containing n sides 112 and at least one protrusion section 126 to form an essentially flat container blank. In some embodiments, n is from 4-8, inclusive, and in the embodiment shown in FIGS. 1-4A and B, n equals 4.

The container blank 102 includes n sidewall sections 114 and each sidewall section has a top 116, a bottom 118, and first and opposing sides, 120 and 122, respectively. The bottom of each sidewall section is attached to a side 112 of the polygonal base section. In some embodiments, all the opposing sides are of equal height.

More specifically, in the embodiment shown in FIG. 2, the base section 104 is square and has four square sidewall sections 114, each sidewall section attached to one of the sides 112 of the square base section by a base section fold line 124. As seen in FIGS. 1, 3, 4A and B, the sidewall sections of the container blank 102 are folded vertically so as to define the sidewalls 114 of the base 102 of the assembled container 100.

The container blank 102 also contains at least one protrusion section 126 having first and second adjoining sides, 128 and 130, respectively and a top protrusion edge 134. The adjoining sides are attached to adjacent opposing sides, 120 and 122, respectively, of adjacent sidewall sections 114 from the bottom 118 of the sidewall section along at least a portion of the sidewall section's side. In some embodiments, all the adjacent sides have an equal length. And in some embodiments, the protrusion sections each include a foldable central seam 132 extending from the intersection 133 of the adjacent sides the length of the protrusion section.

In some aspects, there are n protrusion sections 126 and in the embodiment shown in FIG. 2, n equals four. Additionally, in the embodiment shown in FIG. 2, each of the protrusion sections is a triangle formed by adjoining sides 128 and 130 and the top protrusion edge 134. The adjoining sides are attached to the adjacent opposing sides by a side section fold line 136 and the central seam 132 bisects the triangle.

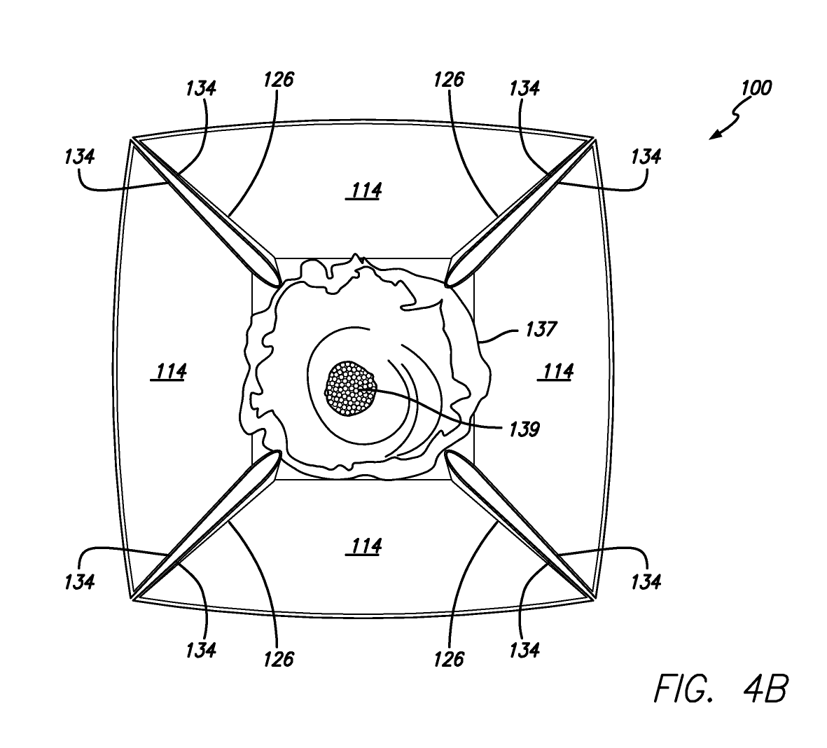

As seen in FIGS. 1, 3 and 4A and B, the protrusion sections 126 are inwardly folded to form protrusions 138 extending inwardly from the corners of the sidewall (which correspond to side section fold lines 136) which engage the sides of an article 137, such as a cupcake or muffin, in the manner shown in FIG. 4B.

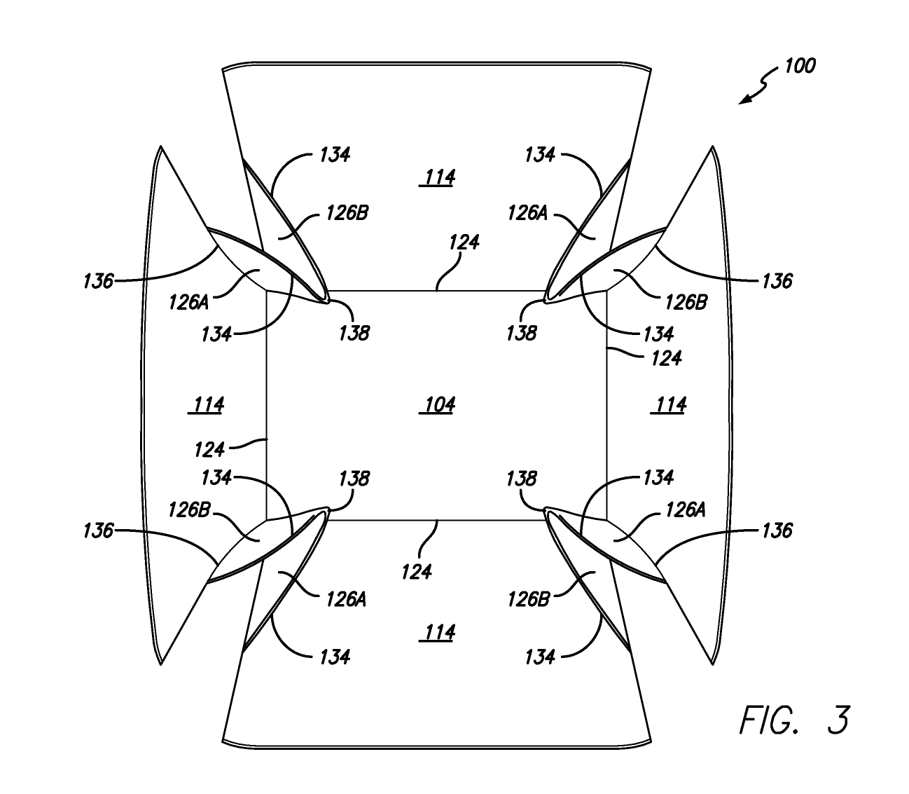

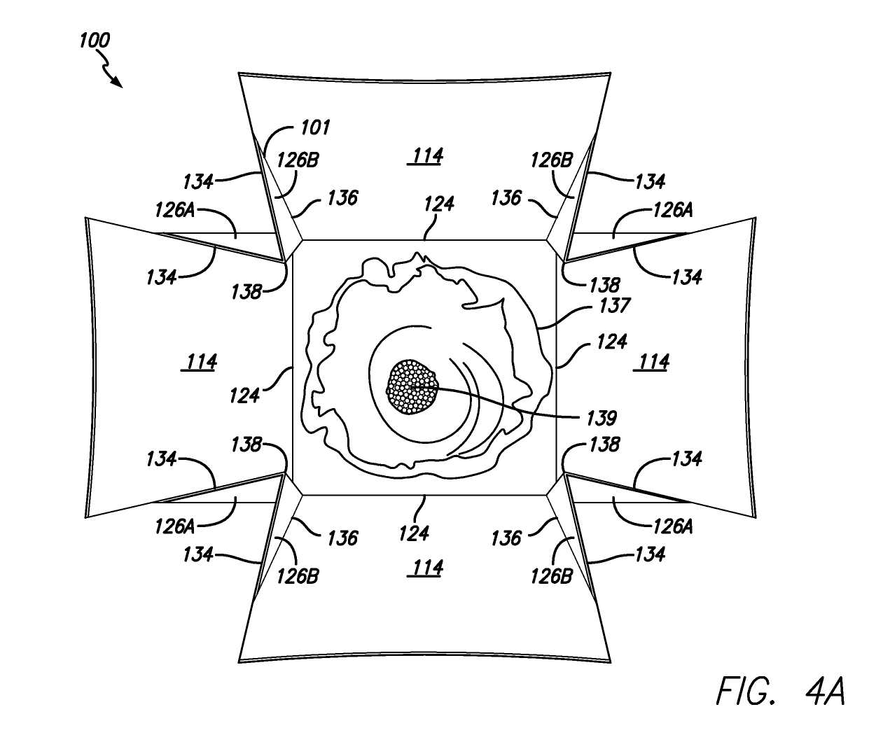

FIGS. 3, 4A and 4B illustrate the protrusions 138 in greater detail. In the embodiment shown in FIGS. 3, 4A and 4B the protrusions are sized so as to engage the base of a cupcake or muffin but not the top of the cupcake or muffin. Generally, it is the top of the cupcake or muffin that has icing or other designs so by contacting only the base of the cupcake or muffin rather than the top, the cupcake or muffin can be secured in the container 100 with less risk of damage to the top of the cupcake or muffin.

The height of the top protrusion edge 134 from the base 104 of the container is fixed by the lengths of the adjoining sides 128 and 130. Where the adjoining sides are of equal length and are connected by top protrusion section edge 134, the height of the protrusion is equal to the length of the adjoining sides. In alternate embodiments, the height of the top protrusion edge can be adjusted by using a top protrusion edge that is not straight, but contains one or more curves. A concave top protrusion edge will lower the height relative the length of the adjoining sides, while a convex top protrusion edge will raise the height. The extension of the protrusion 138 can be controlled by the length of the top protrusion edge with the extent of protrusion being one-half the length of the protrusion edge.

As seen in FIGS. 3, 4A and B, the container blank can be folded to form a container 100 having a polygonal base 104 with n sides, where n is an integer between 4 and 8, inclusive, n adjacent sidewalls 114, and at least one protrusion 138. Each sidewall has a top, a bottom 11, and first and opposing sides. In the embodiment shown in FIGS. 3, 4A and B, n equals 4. The bottom of each sidewall is attached to a side of the polygonal base. The first side of each sidewall forms a corner 136 with the second side of the adjacent sidewall and each protrusion extends inwardly from one of the corners sidewall sections.

It is an advantage of the invention that the container 100 can be configured to hold a wide variety of articles, including cupcakes 137, and, in particular cupcakes with a frosting topping 139 on a base (not shown), and muffins on multiple sides without undue indentation into the base of the muffin or cupcake. Typically, such cupcakes and muffins have a base diameter of from about 1½ inch to about 2½ inch, and, in some embodiments about 2 inches, and a base height of from about ½ inch to about 1½ inch, and in some embodiments about 1 inch. Representative containers for holding such items have a height of from about 1½ inches to about 2½ inches and in some embodiments about 2 inches. In embodiments where the base of the container has four sides of equal length, the length of the sides may be from about 3 inches to about 4 inches and in some embodiments about 3½ inches.

To retain such a cupcake or muffin, in some embodiments, the protrusions 126 extend from the corner 136 of adjacent sidewalls 114 at a height of from about 1 inch to about 2 inches, and in some embodiments about 1.5 inch above the base 104, and extend inwardly from the corners at a distance of from ½ to about 1¼ inch and in some embodiments about ¾ inch.

In this way, the cupcake or muffin can be retained in the container so as to not slide around, but the larger frosted top of the cupcake does not contact the interior surface of either the container 100 or the lid 104. Thus the likelihood of damage or disfigurement of the top of the cupcake is reduced.

FIGS. 4A and B illustrate the manner of use of the container 100 in greater detail. As shown in FIG. 4A, the cupcake 137 is positioned on the base section 104 before the sidewall sections 114 and the protrusion sections 126 are folded. Once the cupcake is on the base section, the sidewall sections and the protrusion sections are then folded to create sidewalls and protrusions, such that the protrusions 132 engage with the base of the cupcake or muffin below the top portion of the cupcake or muffin. As the protrusion sections are positioned below the top of the cupcake or muffin, the larger diameter top of the cupcake or muffin does not touch the sidewalls and the cupcake or muffin is retained from moving by the protrusions.

The assembled container 100 may be secured by any suitable means. For example, in some embodiments the two sides of the protrusion 126 a and b (as best seen in FIG. 3) are fixed to one another such as by gluing or clipping the together. Alternatively, in some embodiments, an elastic band is placed around the outer circumference of the container.

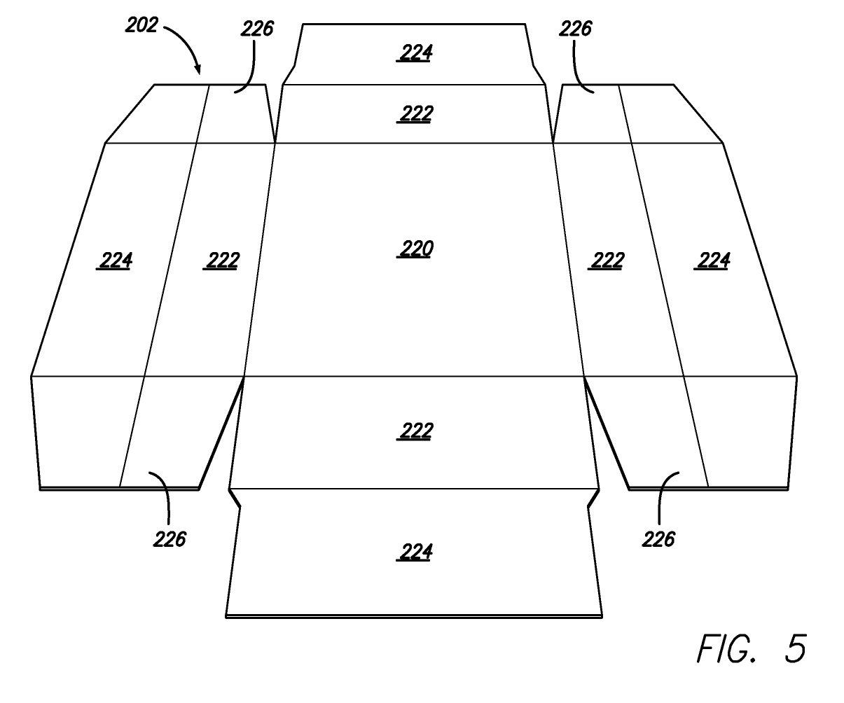

In the embodiment shown in FIG. 1, the container 100 is secured with the lid 104. FIG. 5 illustrates a blank 202 for cover 104. The lid blank may be formed partially or completely out of a sheet of thin, foldable material, such as cardboard, paperboard, paper stock, corrugated, plastic, synthetic material, or combinations thereof. The lid blank includes a top 220 and four sidewalls 222. The sidewalls include folded sections 224 that are folded over in the manner shown in FIG. 1 to provide reinforcement for the lid. Tabs 226 are also formed so that the folded sections can be interconnected and the lid held together. The lid 104 is preferably sized so as to be slightly larger than the container 102 so that the sidewalls 222 are positioned outwards of the sidewalls 114 of the container yet hold the assembled container together.

While the foregoing has shown, illustrated and described various novel features of the present invention, it will be apparent that various changes, modifications and alterations in the structure and use can be made by those skilled in the art without departing from the spirit or scope of the present invention. Thus, the scope of the present invention should not be limited to the foregoing description.

1. A container blank comprising
a polygonal base section having n sides, where n is an integer between 4 and 8, inclusive;
n sidewall sections, each sidewall section having a top, a bottom, and first and opposing sides, the bottom of each sidewall section attached to one of the opposing side of the polygonal base section; and
at least one protrusion section, each protrusion section having first and second adjoining sides, the adjoining sides attached to adjacent sides of adjacent sidewall sections, and a top protrusion edge together forming an essentially flat container blank.

2. The container blank of claim 1 wherein each of the sidewall sections is attached to one of the sides of the polygonal base section by a base section fold line and each of the adjoining sides is attached to one of the adjacent sides of one of the adjacent sidewall sections by a side section fold line.

3. The container blank of claim 2 wherein each of the protrusion sections includes a foldable seam extending from the intersection of the adjacent sides the length of the protrusion section.

4. The container blank of claim 1 wherein the adjoining sides of the at least one protrusion section are attached to adjacent opposing sides of adjacent sidewall sections from the bottom of the sidewall section along at least a portion of the sidewall section's side.

5. The container blank of claim 1 where the top protrusion edge is straight, is convex or is concave.

6. The container blank of claim 1 where the top protrusion edge is straight.

7. The container blank of claim 1 wherein n is 4

8. A container comprising
a polygonal base having n sides, where n is an integer between 4 and 8, inclusive;
n adjacent sidewalls, each sidewall having a top, a bottom, and first and opposing sides, the bottom of each sidewall attached to one of the sides of the polygonal base and the first side of each sidewall forming a corner with the second side of the adjacent sidewall; and
at least one protrusion, each protrusion having a top protrusion edge extending inwardly from one of the sidewall corners.

9. The container of claim 8 wherein the at least one top protrusion edge is disposed between the top and the bottom of the sidewall corner.

10. The container of claim 8 where the top protrusion edge is straight is convex or is concave.

11. The container blank of claim 8 where the top protrusion edge is straight.

12. The container of claim 8 wherein n is 4.

13. The container of claim 8 further comprising means for securing the sidewalls in an upright position.

14. The container of claim 13 wherein the means for securing the sidewalls is an upright position is a lid.

15. A packaged article comprising:
an article disposed in
a container comprising
a polygonal base having n sides, where n is an integer between 4 and 8, inclusive;
n adjacent sidewalls, each sidewall having a top, a bottom, and first and opposing sides, the bottom of each sidewall attached to a side of the polygonal base and the first side of each sidewall forming a corner with the second side of the adjacent sidewall; and
at least one protrusion, each protrusion having a top protrusion edge extending inwardly from one of the sidewall corners, and each protrusion engaging the item.

16. The packaged article of claim 15 wherein each protrusion extends into the article.

17. The packaged article of claim 15 wherein the article is a cupcake or a muffin.

18. The packaged article of claim 17 wherein n is 4.

19. The packaged article of claim 18 wherein the container has a height of from about 1½ inches to about 2½ inches, the base has four sides of equal length, the length of each of the sides being from about 3 inches to about 4 inches, and each protrusions extends from the sidewall corner of adjacent sidewalls at a height of from about 1 inch to about 2 and extends inwardly from the sidewall corners at a distance of from ½ to about 1¼.

20. The packaged article of claim 19 wherein the item is a cupcake having a circular base and a frosting topping, the base diameter being from about 1½ inch to about 2½ inch and the height of the base being in some embodiments about 2 inches and a base from about ½ inch to about 1½.
